(19) United States
(12) Patent Application Publication
(10) Pub. No.: US 2025/0317427 A1
(43) Pub. Date: Oct. 9, 2025

(54) ENHANCED INDICATING AND ENABLING TRANSMISSION CONTROL PROTOCOL/INTERNET PROTOCOL-BASED NETWORK TRANSPORT LAYER NUMBERS USING AN APPLICATION PROGRAMMING INTERFACE

(71) Applicant: CenturyLink Intellectual Property LLC, Denver, CO (US)

(72) Inventor: Asghar HUSSAIN, McLean, VA (US)

(73) Assignee: CenturyLink Intellectual Property LLC, Denver, CO (US)

(21) Appl. No.: 19/093,054

(22) Filed: Mar. 27, 2025

Related U.S. Application Data
(60) Provisional application No. 63/631,920, filed on Apr. 9, 2024.

(51) Int. Cl. H04L 9/40

(52) U.S. Cl. CPC H04L 63/08

(57) ABSTRACT

This disclosure describes devices, systems, and methods for connecting a device to a transmission control protocol (TCP) port of a server. A method may include receiving, by an application programming interface (API) portal, a first request from a user device to connect to a TCP transport layer of a server; authenticating, by the API portal, the user device based on the first request; providing, by the API portal, to the server, based on the authenticating, a second request to access to a TCP port of the server; receiving, by the API portal, from the server, a response to the second request, indicating that the user device is permitted to access the TCP port; and sending, by the API portal, to the user device, a response to the first request, the response to the first request indicating that the user device is permitted to access the TCP port.

### CROSS-REFERENCE TO RELATED APPLICATIONS

This application claims the benefit of priority from U.S. Provisional Application Ser. No. 63/631,920, filed Apr. 9, 2024, which is incorporated herein by reference in its entirety.

### TECHNICAL FIELD

Embodiments of the present disclosure generally relate to devices, systems, and methods for indicating and enabling transmission control protocol/Internet protocol-based network transport layer numbers.

### BACKGROUND

In the Open Systems Interconnection model, programs running in the background listen for requests at the transport layer. The operating kernel assigns a number for the port to which the daemon is listening. The programs provide essential network functionality service and are running in the background, constantly listening and waiting for requests. As a result, a device on the internet can connect to these services and use them, possibly resulting in a network vulnerability.

### SUMMARY

According to some embodiments, a method for connecting a device to a transmission control protocol (TCP) port of a server is disclosed, which can include receiving, by an application programming interface (API) portal, a first request from a user device to connect to a TCP transport layer of a server; authenticating, by the API portal, the user device based on the first request; providing, by the API portal, to the server, based on the authenticating, a second request to access to a TCP port of the server; receiving, by the API portal, from the server, a response to the second request, indicating that the user device is permitted to access the TCP port; and sending, by the API portal, to the user device, a response to the first request, the response to the first request indicating that the user device is permitted to access the TCP port.

According to some embodiments, a device of an application programming interface (API) portal for connecting a device to a transmission control protocol (TCP) port of a server is disclosed, where the device can include memory coupled to processing circuitry, wherein the processing circuitry is configured to: receive a first request from a user device to connect to a TCP transport layer of a server; authenticate the user device based on the first request; provide, to the server, based on the authenticating, a second request to access to a TCP port of the server; receive, from the server, a response to the second request, indicating that the user device is permitted to access the TCP port; and send, to the user device, a response to the first request, the response to the first request indicating that the user device is permitted to access the TCP port.

According to some embodiments, a system for connecting a device to a transmission control protocol (TCP) port of a server is disclosed, where the system can include: an application programming interface (API) portal; one or more TCP ports of a server; and memory coupled to processing circuitry, wherein the processing circuitry is configured to: receive, by the API portal, a first request from a user device to connect to a TCP transport layer of the server; authenticate, by the API portal, the user device based on the first request; provide, by the API portal, to the server, based on the authenticating, a second request to access to a TCP port of the server; receive, by the API portal, from the server, a response to the second request, indicating that the user device is permitted to access the TCP port; and send, by the API portal, to the user device, a response to the first request, the response to the first request indicating that the user device is permitted to access the TCP port.

### BRIEF DESCRIPTION OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 shows example systems for connecting to services via a server, in accordance with one embodiment of the present disclosure;

FIG. 2 shows an example system for connecting to services via a server, in accordance with one embodiment of the present disclosure;

FIG. 3 is flow for an example process for connecting to services via a server, in accordance with one embodiment of the present disclosure; and

FIG. 4 is a diagram illustrating an example of a computing system that may be used in implementing embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, as discussed herein, aspects of the present disclosure involve systems, devices, and methods for indicating and enabling transmission control protocol/Internet protocol (TCP/IP)-based network transport layer numbers using an application programming interface (API).

In the Open Systems Interconnection (OSI) networking model, programs running in the background known as daemons (e.g., using original Unix/Linux terminology) listen for requests at the Transport Layer (e.g., the International Organization for Standardization OSI networking model). This is also known as listening on a TCP port. The operating kernel assigns a number for the port (e.g., 0-65535 or 2\hat{ }16). So, by default, a program listening for SSH (Secure Shell) connections will listen on port 22, a program listening for HTTP connections will listen on port 80 and a program listening for HTTPS connections will listen on port 443. The idea is that these programs provide essential network functionality service and are running in the background, constantly listening/waiting for requests. As such, unless filtered, any device on the internet might connect to these services and use them (e.g., although in many cases authorization is needed). As such, this is an inherently insecure situation because the daemons are listening all the time.

The present disclosure provides network security enhancements by only enabling the TCP transport layer daemon to listen on a random port. To enable this protection, a client may call an authenticated API service to request the API service to allow the client to use the TCP transport layer service of a server. If the API service authenticates the client, the API service may call the server and request opening a port for the client by allowing the client through a firewall/filter. When the server allows the client based on the API service's request, an acknowledgement may be provided by the API service to the client to confirm that the client has been allowed on the server. The API service may attach a daemon that provides the requested functionality (e.g., SSH, HTTP, HTTPS) to a random TCP port of the server and may forward the TCP port number to the client. When the client receives the TCP port number from the API service, the client may connect to the server's TCP port and receive the requested service. When the client is not authenticated, the API service may send a rejection response to the client. As a result, an attacker attempting to access the server would not be authenticated by the API portal and would therefore be denied access to the server.

Some existing techniques to limit access to servers include allowed/denied access lists that include lists of devices/addresses allowed or not allowed to access the server. However, such lists are static, whereas device Internet Protocol (IP) addresses may change. Therefore, when a device's IP address changes, the device would need to authenticate to the API portal again to access the server for requested service. By requiring authentication of the IP address via the API portal in order to allow access to the server, attacks may be mitigated because the server ports are not open without the authentication to approve a device's IP address, for example.

The above descriptions are for purposes of illustration and are not meant to be limiting. Numerous other examples, configurations, processes, etc., may exist, some of which are described in greater detail below. Example embodiments will now be described with reference to the accompanying figures.

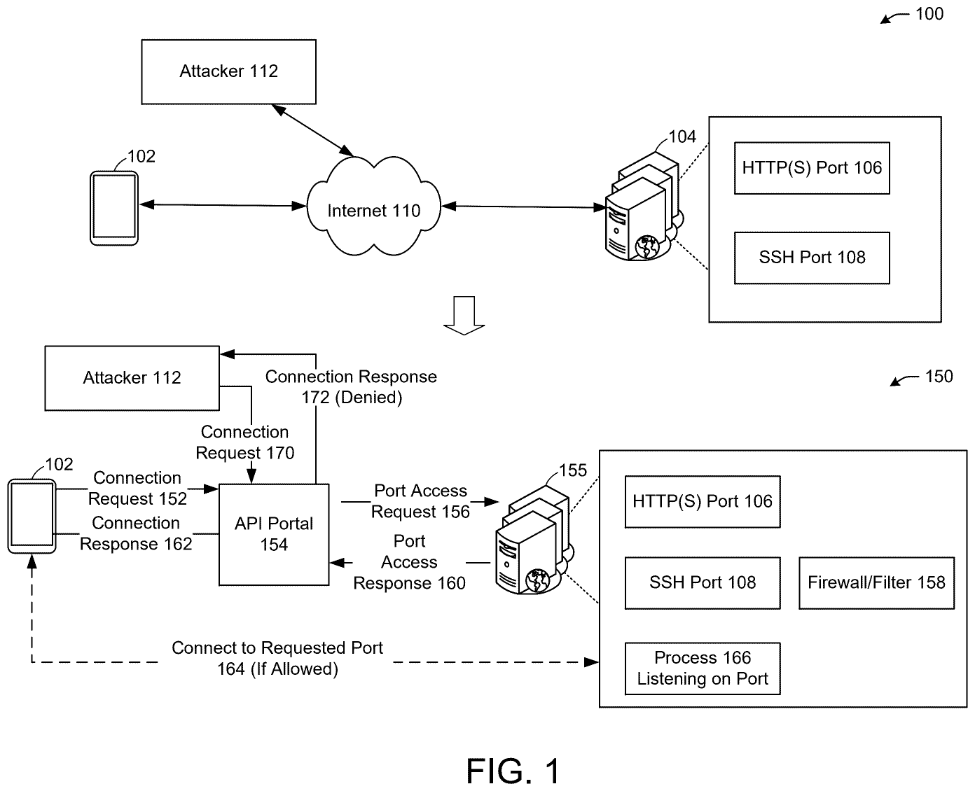

FIG. 1 shows example systems for connecting to services via a server, in accordance with one embodiment.

Referring to FIG. 1, a system 100 may include a user device 102 connecting to a server 104 (e.g., a HTTP(S) port 106 or SSH port 108), via the Internet 110, for service provided by the server 104. As a result, the port of the server 104 to which the user device 102 connects may be open, and an attacker 112 may listen to the port, creating a possible security vulnerability.

Still referring to FIG. 1, the possible vulnerability of the system 100 may be mitigated by the system 150 in which the user device 102 may send a connection request 152 to an API portal 154, requesting connection to a port of a server 155. The connection request 152 may include credentials with which the API portal 154 may authenticate the user device 102. In response to the connection request 152, the API portal 154 may authenticate the user device 102 based on the received credentials. When the user device 102 has been authenticated to the API portal 154, the API portal 154 may send a port access request 156 to the server 155 to allow the user device 102 to connect to a port (e.g., the port optionally specified by the connection request 152). To allow the user device 102 to connect to a port of the server 155, the server may implement a firewall/filter 158 and may add the user device 102 to the firewall/filter 158 as a permitted device. When the user device 102 has been allowed or not allowed by the firewall/filter 158, the server 155 may provide a port access response 160 to the API portal 154, which may provide a connection response to the user device 102 acknowledging the connection request 152 and either confirming the allowed connection (e.g., optionally including the port at the server 155 to which the user device 102 may connect) or denying the connection request 152. When the user device 102 is permitted to connect to the port as requested, the user device 102 may connect to the requested port 164 at the server 155. A process 166 (e.g., daemon) may be attached to the requested port of the server 155 to listen to the port and provide the requested functionality (e.g., SSH, HTTP(S), etc.). In this manner, the port is only opened based on authenticating the user device 102, and the user device 102 then connects to the port for its requested service.

As a result, if the attacker 112 attempts a connection request 170 to the API portal 154, the API portal 154 may fail to authenticate the attacker 112, and therefore may respond with a connection response 172 denying the attacker 112 access to the server 155.

In one or more embodiments, the IP address of the user device 102 may change, such as when the device changes its connection, moves to another location, or receives an updated IP address for any other reason. When the IP address of the user device 102 changes, the user device 102 may repeat the authentication process by sending an updated connection request 152 with its credentials, and the API portal 154 may authenticate the user device 102 for the server 155 using the updated IP address of the user device 102.

In one or more embodiments, the API portal 154 may use one or more API protocols, such as REST (representational state transfer), SOAP (simple objects access protocol), GraphQL, remote procedural call, or the like.

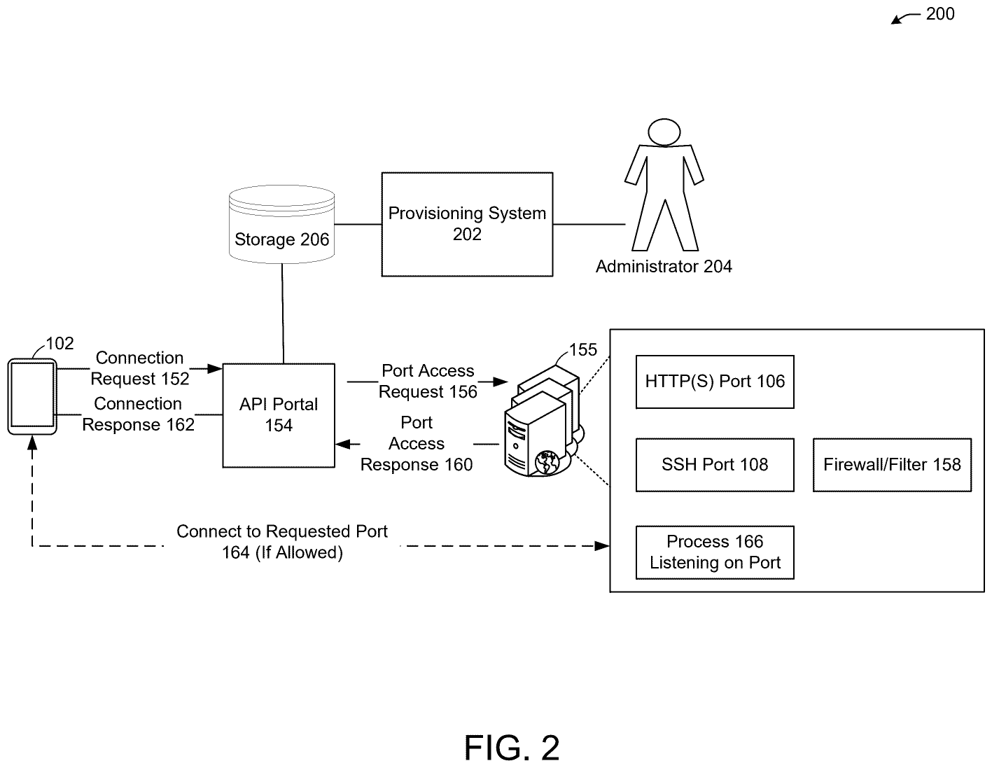

FIG. 2 shows an example system 200 for connecting to services via a server, in accordance with one embodiment.

Referring to FIG. 2, the user device 102 may authenticate to the API portal 154 using the connection request 152 and the connection response 162, the API portal 154 may provide the port access request 156 to and receive the port access response from the server 155, and the user device 102 may connect to the requested port 164. FIG. 2 provides additional details regarding the provisioning for authentication of the user device 102. In particular, the API portal 154 may use a provisioning system 202 maintained by an administrator 204. The provisioning system 202 may use storage 206 for storing user device credentials so that, when the API portal 154 receives the connection request 152, the API portal 154 may authenticate the user device 102 based on credentials stored in the storage 206 and whether they match credentials provided in the connection request 152.

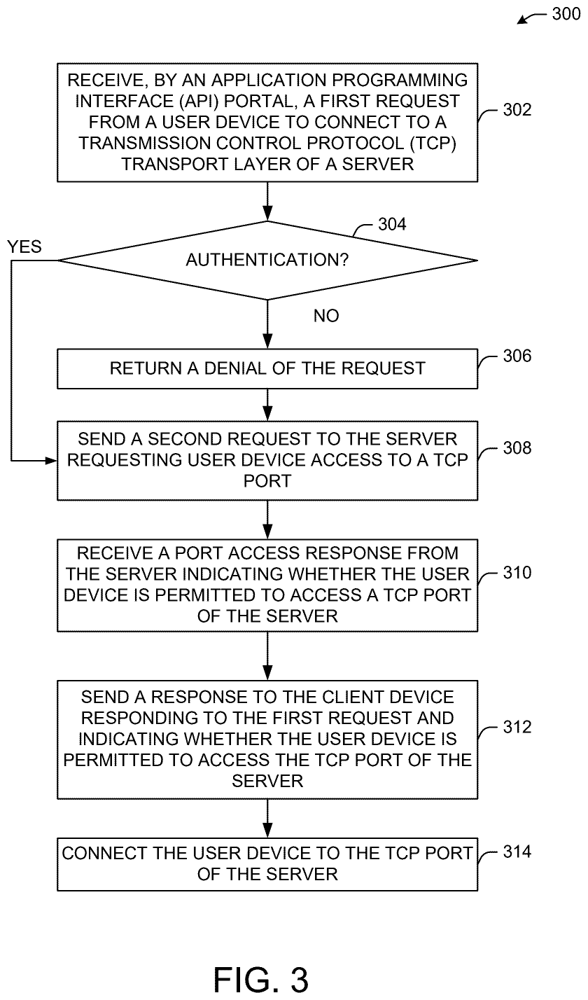

FIG. 3 is flow for an example process 300 for connecting to services via a server, in accordance with one embodiment.

At block 302, an API portal (e.g., the API portal 154 of FIG. 1) may receive a first request (e.g., the connection request 152) from a user device to connect to a transport layer of a server (e.g., the server 155). The first request optionally may specify the TCP port of the server to which the user device is requesting to connect. The first request may include user credentials and an IP address of the first device.

At block 304, the API portal may attempt to authenticate the user device based on the provided credentials in the first request. When authentication fails (e.g., in the case of an attacker without the proper credentials), at block 306 the API portal may deny the requesting device. When authentication occurs, at block 308 the API portal may send a second request (e.g., the port access request 156) to the server requesting user device access to a TCP port of the server by adding the IP address of the user device to a firewall/filter of the server.

At block 310, the API portal may receive a port access response from the server indicating whether the user device is permitted to access a TCP port of the server. In this manner, the server may not update its permitted user device list unless the user device is first authenticated by the API portal.

At block 312, the API portal may send a response to the user device, responding to the first request, to indicate whether the user device is permitted to access the TCP port of the server. The response may include an indication of the TCP port, or there may be a default TCP port to which the user device may attempt to connect without the response specifying the port.

At block 314, the user device may connect to the TCP port of the server by requesting the connection. The server may identify the IP address of the user device and verify that the IP address is included in the permitted list before allowing the connect.

It is understood that the above descriptions are for purposes of illustration and are not meant to be limiting.

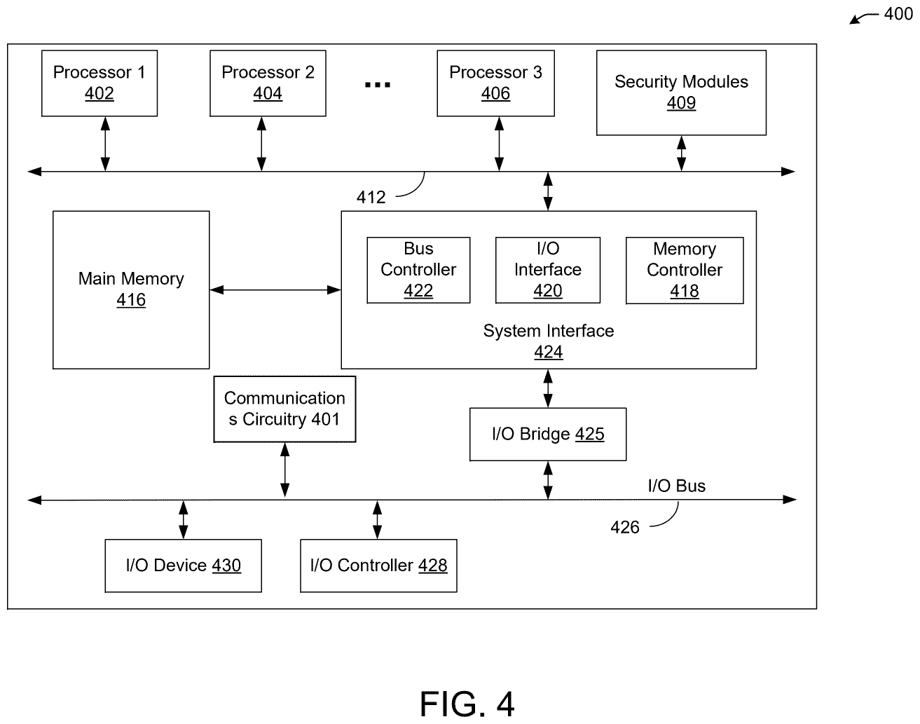

FIG. 4 is a block diagram illustrating an example of a computing device or computer system 400 which may be used in implementing the embodiments of the components of the network disclosed above. For example, the computing system 400 of FIG. 6 may represent the user device 102, the API portal 154, and/or the server 155 of FIG. 1.

The computer system 400 may include communications circuitry 401 for sending and receiving wireless signals, including authentication requests and responses, connection requests and responses, and other communications described herein. The communications circuitry 401 may include circuitry that can operate the physical layer (PHY) communications and/or medium access control (MAC) communications for controlling access to the wireless medium, and/or any other communications layers for transmitting and receiving signals.

In accordance with some embodiments, the communications circuitry 401 may be arranged to contend for a wireless medium and configure frames or packets for communicating over the wireless medium. The communications circuitry 401 may be arranged to transmit and receive signals. The communications circuitry 401 may also include circuitry for modulation/demodulation, upconversion/downconversion, filtering, amplification, etc. In some embodiments, the communications circuitry 401 may include two or more antennas arranged for sending and receiving signals. The antennas may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

The computer system 400 (system) optionally may include one or more processors 402-406, and security modules 409 (e.g., hardware and/or software) capable of performing at least some of the functions in FIGS. 1-3 as described herein. Processors 402-406 may include one or more internal levels of cache (not shown) and a bus controller 422 or bus interface unit to direct interaction with the processor bus 412. Processor bus 412, also known as the host bus or the front side bus, may be used to couple the processors 402-406 with the system interface 424. System interface 424 may be connected to the processor bus 412 to interface other components of the system 400 with the processor bus 412. For example, system interface 424 may include a memory controller 418 for interfacing a main memory 416 with the processor bus 412. The main memory 416 may include one or more memory cards and a control circuit (not shown). System interface 424 may also include an input/output (I/O) interface 420 to interface one or more I/O bridges 425 or I/O devices with the processor bus 412. One or more I/O controllers and/or I/O devices may be connected with the I/O bus 426, such as I/O controller 428 and I/O device 430, as illustrated.

I/O device 430 may also include an input device (not shown), such as an alphanumeric input device, including alphanumeric and other keys for communicating information and/or command selections to the processors 402-406. Another type of user input device includes cursor control, such as a mouse, a trackball, or cursor direction keys for communicating direction information and command selections to the processors 402-406 and for controlling cursor movement on the display device.

System 400 may include a dynamic storage device, referred to as main memory 416, or a random access memory (RAM) or other computer-readable devices coupled to the processor bus 412 for storing information and instructions to be executed by the processors 402-406. Main memory 416 also may be used for storing temporary variables or other intermediate information during execution of instructions by the processors 402-406. System 400 may include a read only memory (ROM) and/or other static storage device coupled to the processor bus 412 for storing static information and instructions for the processors 402-406. The system outlined in FIG. 4 is but one possible example of a computer system that may employ or be configured in accordance with aspects of the present disclosure.

According to one embodiment, the above techniques may be performed by computer system 400 in response to processor 404 executing one or more sequences of one or more instructions contained in main memory 416. These instructions may be read into main memory 416 from another machine-readable medium, such as a storage device. Execution of the sequences of instructions contained in main memory 416 may cause processors 402-406 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 406 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 416, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations together with all equivalents thereof.

What is claimed is:

1. A method comprising:
receiving, by an application programming interface (API) portal, a first request from a user device to connect to a transmission control protocol (TCP) transport layer of a server;
authenticating, by the API portal, the user device based on the first request;
providing, by the API portal, to the server, based on the authenticating, a second request to access to a TCP port of the server;
receiving, by the API portal, from the server, a response to the second request, indicating that the user device is permitted to access the TCP port; and
sending, by the API portal, to the user device, a response to the first request, the response to the first request indicating that the user device is permitted to access the TCP port.

2. The method of claim 1, wherein the first request specifies the TCP port.

3. The method of claim 1, wherein the first request does not specify the TCP port, and wherein the response to the second request and the response to the first request specify the TCP port.

4. The method of claim 1, further comprising:
attaching a TCP transport layer daemon to the TCP port in response to the second request.

5. The method of claim 4, wherein attaching the TCP transport layer daemon to the TCP port is based on adding an Internet Protocol (IP) address of the user device to a firewall or filter in response to the second request.

6. The method of claim 5, further comprising:
establishing a connection between the user device and the TCP port based on the IP address.

7. The method of claim 1, further comprising:
receiving, by the API portal, from a second user device, a third request to access the TCP port;
determining, by the API portal, that the second user device cannot authenticate to the API portal; and
denying, by the API portal, the second user device access to the TCP port by not requesting the server to add a second IP address of the second user device to a firewall or filter.

8. A device comprising:
memory coupled to processing circuitry, the processing circuitry is configured to:
receive a first request from a user device to connect to a transmission control protocol (TCP) transport layer of a server;
authenticate the user device based on the first request;
provide, to the server, based on the authenticating, a second request to access to a TCP port of the server;
receive, from the server, a response to the second request, indicating that the user device is permitted to access the TCP port; and
send, to the user device, a response to the first request, the response to the first request indicating that the user device is permitted to access the TCP port.

9. The device of claim 8, wherein the first request specifies the TCP port.

10. The device of claim 8, wherein the first request does not specify the TCP port, and wherein the response to the second request and the response to the first request specify the TCP port.

11. The device of claim 8, wherein the processing circuitry is further configured to:
attach a TCP transport layer daemon to the TCP port in response to the second request.

12. The device of claim 11, wherein to attach the TCP transport layer daemon to the TCP port is based on adding an Internet Protocol (IP) address of the user device to a firewall or filter in response to the second request.

13. The device of claim 12, wherein the processing circuitry is further configured to:
establish a connection between the user device and the TCP port based on the IP address.

14. The device of claim 8, wherein the processing circuitry is further configured to:
receive, from a second user device, a third request to access the TCP port;
determine that the second user device cannot authenticate to the API portal; and
deny the second user device access to the TCP port by not requesting the server to add a second IP address of the second user device to a firewall or filter.

15. A system comprising:
an application programming interface (API) portal;
one or more transmission control protocol (TCP) ports of a server; and
memory coupled to processing circuitry, wherein the processing circuitry is configured to:
receive, by the API portal, a first request from a user device to connect to a TCP transport layer of the server;
authenticate, by the API portal, the user device based on the first request;
provide, by the API portal, to the server, based on the authenticating, a second request to access to a TCP port of the server;
receive, by the API portal, from the server, a response to the second request, indicating that the user device is permitted to access the TCP port; and
send, by the API portal, to the user device, a response to the first request, the response to the first request indicating that the user device is permitted to access the TCP port.

16. The system of claim 15, wherein the first request specifies the TCP port.

17. The system of claim 15, wherein the first request does not specify the TCP port, and wherein the response to the second request and the response to the first request specify the TCP port.

18. The system of claim 15, wherein the processing circuitry is further configured to:
attach a TCP transport layer daemon to the TCP port in response to the second request.

19. The system of claim 18, wherein to attach the TCP transport layer daemon to the TCP port is based on adding an Internet Protocol (IP) address of the user device to a firewall or filter in response to the second request, wherein the processing circuitry is further configured to:
establish a connection between the user device and the TCP port based on the IP address.

20. The system of claim 15, wherein the processing circuitry is further configured to:
receive, from a second user device, a third request to access the TCP port;
determine that the second user device cannot authenticate to the API portal; and
deny the second user device access to the TCP port by not requesting the server to add a second IP address of the second user device to a firewall or filter.
